(19) United States
(12) Patent Application Publication
(10) Pub. No.: US 2016/0117896 A1
(43) Pub. Date: Apr. 28, 2016

(54) METHOD AND EVALUATION DEVICE FOR EVALUATION OF SIGNALS FROM A LED STATUS INDICATOR

(71) Applicant: ELESTA GmbH, Bad Ragaz (CH)

(72) Inventors: Roman Steiner, Ernetschwil (CH); Andre Sulser, Berneck (CH)

(73) Assignee: ELESTA GmbH, Bad Ragaz (CH)

(21) Appl. No.: 14/922,855

(22) Filed: Oct. 26, 2015

(30) Foreign Application Priority Data
Oct. 24, 2014 (CH) 01638/14

(51) Int. Cl. G08B 5/36

(52) U.S. Cl. CPC G08B 5/36

(57) ABSTRACT

The invention relates to a method for evaluation of signals from a LED status indicator of a device, in particular a safety device, comprising the steps
detecting a signal emitted by the LED status indicator by means of a camera of a portable evaluation device,
comparing the detected signal with signals stored in a database, wherein a status is associated in each case with the stored signals in the database,
displaying information about the status which is associated with the detected signal by means of a display means of the portable evaluation device,
wherein the emitted signal in the form as emitted by the LED status indicator is not distinguishable or not unambiguously distinguishable by the human eye from other signals which can be emitted by the LED status indicator.

### CROSS REFERENCE TO RELATED APPLICATIONS

This application claims priority to Swiss Patent Application No. 01638/14 filed Oct. 24, 2014, the entirety of which is incorporated by this reference.

### TECHNICAL FIELD

The invention relates to a method for the evaluation of signals from a LED status indicator of a device. In this case, safety devices which may for example be part of a safety system are of particular interest. Furthermore, a portable evaluation device as well as a system for carrying out the method are the subject of the present invention.

### PRIOR ART

LED status indicators are a cost-effective type of status or error indicator generally comprising 1 to 10 LEDs (light-emitting diodes). Normally the LEDs of the display emit in the wavelength range visible to the human eye and indicate, by their color and/or flashing frequency as well as the selection of active LEDs in the status indicator, the status of the device provided with the status indicator. The individual LEDs can be provided with an inscription which explains the significance of an emission by the different LEDs. This is customary in particular in the case of devices for private use, such as for example printers or coffee machines. In the case of devices for industrial use such a legend is quite frequently omitted. If no inscription or no sufficiently informative inscription is present, the user must compare the signals emitted by the LEDs signals with a list of possible signals in order to identify the indicated device status. Since the status indicator is read directly by the user, the different signals emitted by the LEDs must be perceptible and distinguishable by the human eye. This has effects not only on the usable wavelengths but also on the speed of the signal emission and thus the evaluation.

In a search carried out by a Patent Office DE102012107575A1 was found, which discloses a method for wireless transmission of information between a welding apparatus and a portable mobile additional device. For carrying out of the method a transmitter with an indicator part and a receiver with a sensor part are provided, wherein information is displayed optically on the indicator part and is captured optically by the sensor part. The information which can be displayed on the indicator part also includes inter alia error codes.

### Advantages of the Invention

An advantage of the present invention is to provide a method for evaluation of signals from a LED status indicator of a device, as well as aids for carrying out the method. The method should enable a simplified and/or faster evaluation of the signals. Further advantages of the present invention are disclosed by the following description.

### SUMMARY OF THE INVENTION

The above-mentioned advantages are achieved by a method, an evaluation device and a.

A method for evaluation of signals from a LED status indicator of a device is disclosed inter alia. The method comprises the following steps:
detecting a signal emitted by the status indicator by means of a camera (as sensor) of a portable evaluation device,
comparing the detected signal with signals which are stored in a database, wherein a status of the device is associated respectively with one the stored signals in the database, and
displaying information about the status which is associated with the detected signal, by means of a display means of the portable evaluation device,
wherein it is advantageous if the emitted signal in the form as emitted by the status indicator is not distinguishable or not unambiguously distinguishable by the human eye from other signals which can be emitted by the status indicator.

Features are described below which should be considered (individually) as desired features, even if they are not designated as such. The features may be disclosed separately (as part of any method for evaluation of signals from a status indicator of a device or any portable evaluation device or any system) or—if they are not precluded—in any combination.

The evaluation device and/or an optional server may be designed for carrying out the method described in this document or parts thereof and/or are programmed for carrying out the method or parts thereof.

A system for signal evaluation is disclosed, including a device having a status indicator as well as a portable evaluation device and optionally a server, wherein the system and/or parts thereof advantageously exhibit one or more of the features described in this document and/or are designed for carrying out the method described in this document.

The detected signal is evaluated. The comparison of the detected signal with signals which are stored in a database is part of the evaluation. Through the comparison a stored signal may be identified which corresponds to the detected signal.

A status of the device is associated in each case with the stored signals.

A plurality of different statuses of the device are provided which are associated with the stored signals, wherein the statuses are likewise stored in a database (stored statuses), such as in the same database as the stored signals. A database may also be provided, containing a plurality of stored signals and a plurality of stored statuses, the stored statuses being associated with the stored signals.

As part of the evaluation an association of the detected signal with a stored status of the device, in particular the association with a defined error, can take place (as a function of the result of the comparison of the detected signal with the stored signals).

The device may be a stationary device. It may for example be installed in a building. A device which is part of a safety device, for example a safety switch or a control device, is of particular interest.

The status indicator can have one or more emitters. The emitter is designed to emit a signal (emitted signal) or a signal part, such as in the form of electromagnetic radiation.

The electromagnetic radiation may include radiation (light, for example white, blue, green, red or yellow light) in the wavelength range which is visible and/or invisible to the human eye (for example infrared radiation or ultraviolet radiation).

The following may be regarded for example as different wavelength ranges: visible radiation, invisible radiation or sub-categories thereof. Sub-categories of visible radiation may be radiation which is perceptible by the human eye as different colors. Sub-categories of invisible radiation may be infrared radiation and ultraviolet radiation.

In this case it is possible that the emitter emits (with regard to the emitted amount of energy) for the most part in one of said wavelength ranges. With regard to the emitted amount of energy the emitter can emit for example at least 60, 70 or 90% in one of said wavelength ranges.

As described, the status indicator may have one or more emitters, such as at least 2, 3 or 5 and/or at most 100, 50 or 20 emitters.

The emitters can be designed to jointly emit a signal (emitted signal) and/or the individual emitters can be designed in each case to emit a part (signal part) of the signal (emitted signal).

If a plurality of emitters are provided, different emitters can emit radiation (predominantly) in the same or in different wavelength ranges (for example light of the same color or light of different colors). The status indicator can for example have 2, 3, 4, 5 or more different emitters which differ with regard to the wavelength range emitted in each case. As described above, the emitters can in each case emit mainly in one wavelength range.

Particularly the emitters may be LEDs (light-emitting diodes). Accordingly the status indicator can advantageously be a LED status indicator.

The emitters can be exposed or covered by the housing of the device, and the covering may be transparent or opaque to visible radiation. If the part of the housing covering the emitters is opaque in this way, the emitters lying below it and the signals emitted by them are not perceptible to the human eye. However, emitters can be used which emit in an invisible wavelength range, for example infrared LEDs. Their emissions can then also be detected by means of the evaluation device, even through the housing.

It is advantageous if the status indicator is designed to or is able to display at least 2, 3, 5 or 10 different statuses of the device indicate and/or to emit at least 2, 3, 5 or 10 different signals for this purpose.

One of the statuses can for example be a normal operational state of the device. It may also be provided that one of the statuses is an erroneous, disrupted, defective or inactive status of the device.

One status—in particular an erroneous, distorted, defective or inactive status—can also be indicated by the absence of an emission.

The emitted signal may be a signal in the form of electromagnetic radiation (cf. above).

It may be provided that the signal in the form as emitted by the status indicator

(A) is not distinguishable or not unambiguously distinguishable from other signals emitted by the status indicator and/or

(B) is not perceptible by human senses (naturally in combination with the human intellectual capacity), in particular by the human eye. This may be the case for example if the signal is emitted in the invisible wavelength range or if the emission and/or the signal is too short for detection by a human.

A signal according to (A) or (B) is collectively designated below as “a signal which cannot be detected by a human”.

The signal can be emitted completely by one emitter of the status indicator or may be composed of emissions from two or more emitters.

Regardless of this it may be advantageous if the signal from the status indicator is or can be emitted completely within less than 10, 5, 3, 1 or 0.5 seconds (designated below as the “time interval for complete emission”. Optionally after the expiry of the time interval for complete emission (in particular within 10, 5, 3, 1 or 0.5 seconds after said time interval) the emission of the signal can be ended and/or the emission of the same signal or a different signal can begin. This operation can advantageously be carried out 1, 2, 3 or more times in succession.

Whilst a human may not be capable of perceiving the signal or distinguishing it from other signals unaided within this time (i.e. the signal constitutes a signal which is cannot be detected by a human), this is made possible by the portable evaluation device. A short time interval for complete emission saves time.

Alternatively or in addition the complete emission of the signal (i.e. the time interval for complete emission) can last longer than 0.000001, 0.0001, 0.01, 0.1, 0.3, 0.5 or 1 second.

Optionally, after the time interval for complete emission, the emission of the signal can end and/or begin again.

The time interval (i.e. time period) for complete emission of the signal may be the minimum time interval for complete emission of the signal.

In connection with the time interval for complete emission “complete” means that the signal can be associated unambiguously with a status.

Alternatively or in addition the signal can be emitted and/or defined by a change to the emission from the emitter or a change to the emitter (for example by flashing). This may involve a change to the emission within a time interval, in particular within the described time interval for complete emission. The change to the emission can for example comprise the change (e.g. 1, 2, 3 or more times) of the configuration of the emission from a plurality of emitters.

The signals which can be emitted are signals for the emission of which the status indicator is designed and/or programmed.

It may be provided that one or more different signals are associated with the status.

The possibility exists of designing the status indicator so that it indicates the status by one, two or more different signals (e.g., simultaneously). The complete emission of these signals associated with the same status can last for different lengths of time and/or the signals can be emitted by different emitters or a different combination of emitters of the status indicator.

A signal which cannot be detected by a human and a signal which can be detected by a human can for example be assigned to the status, and the status indicator can emit both signals (e.g., simultaneously). Optionally it is possible to switch between the two types of indication (signal which can/cannot be detected by a human). In an emergency the status indicator can also be read by a human directly, that is to say without the aid an evaluation device.

In particular one or more emitters can emit the status (i.e. the current device status) by means of a signal which cannot be detected by a human, whereas one or more other emitters of the status indicator emit the status in the form of a signal which can be detected by a human. However, it is also possible that the same or partially the same emitters emit two signals (simultaneously).

An advantage of such a configuration reside in the fact that the device status can be selectively detected by means of an evaluating device or without an evaluation device, wherein detection by means of the evaluation device may be possible more quickly, for example within half a second.

Limits can be set for the indication by means of signals which can be detected by a human (for example because too few emitters are present, in order to indicate many different statuses distinguishably within a reasonable time). The indication by means of signals which cannot be detected by a human enables a more precise breakdown of different statuses when there are a large number of statuses.

When reference is made in this document to a “signal”, then in each case a signal (usual meaning of the word) and alternatively the information carried by the signal may be disclosed in so far as this makes sense in the respective context.

The status indicator is advantageously designed in order to carry out one or more of the actions described in connection with the status indicator and/or the emitters.

It is advantageous, if the detection of the signal emitted by the status indicator takes place contactlessly through the sensor, in particular that the evaluation device for detecting the signal is not physically connected to the device or to the status indicator thereof.

The sensor of the portable evaluation device is designed to and/or is able to detect the signal emitted by the status indicator. This may involve an optical sensor, in particular an optoelectronic sensor. The sensor is may be a camera.

The sensor is disposed on the evaluation device and is may be firmly connected thereto.

It is advantageous if the sensor is designed to and/or is able to detect a change to the emission from the status indicator and/or the emission from the emitter during a time interval. This may constitute a part of the detection of the signal emitted by the status indicator and/or a part of the detection of an optionally emitted identification feature (cf. below). For this purpose the sensor may be able to and/or is designed to detect (i.e. to record) and also to store a video sequence and or a sequence of (for example at least 2, 5 or 10) individual images during said time interval. Said time interval can advantageously correspond to the above-mentioned “time interval for complete emission of the signal”.

The video sequence or the individual images can contain information about the change to the emission described above and after the detection they can be evaluated as part of the method disclosed in this document. The video sequence or the individual images (individually and/or in combination with one another) may contain the signal or the identification feature or information relating thereto.

The evaluation device can have an input means, for example buttons or keys, but this is not absolutely necessary.

In addition to the sensor the evaluation device may have an indicator device, in particular a monitor screen or a display, for example a LCD display or a LED display.

The evaluation device can be designed to display signs, in particular text and/or images, on the display means. Thus for example the described information about the status of the device can be displayed to the user.

Alternatively or in addition it may be provided that the display means is designed to serve additionally as an input means. For this purpose the display means can for example be a touch screen.

On the one hand the display means and/or the input means and on the other hand the sensor can be attached to two different sides, in particular to two opposing sides of the portable evaluation device, so that during the signal detection the user can look at the display means and/or can operate the input means.

The method comprises the display of information about the status which is associated with the detected signal, by means of the display means of the portable evaluation device.

Alternatively or in addition to this, the method may include carrying out another action as a function of the status associated with the detected signal. For example, as such an action, the evaluation device can transmit data and/or a command to a target device (for example the status indicator and/or the device and/or the server), wherein the command may be a command for execution of software by the target device. In this way for example the device can be prompted to initiate steps to remedy a malfunction.

The method provides for a comparison of the signal detected by means of the sensor with signals which are stored in a database. The same applies to optionally detected identification features and the comparison thereof with stored identification features (cf. below).

The comparison can be carried out by a data processing unit designed and/or programmed for this purpose such as for example a microchip, microcontroller or computer.

One or more arbitrary further evaluation steps (for example the evaluation of the signals mentioned in this document and/or identification features and/or statuses and/or information) can likewise be carried out by the data processing unit. In addition to the aforementioned comparison, such evaluation steps may also be the association of information mentioned in this document (for example the association of signals with statuses).

The data processing unit can be located in the portable evaluation device or in a server disposed remotely therefrom, or both can have a data processing unit, and it may then be provided that some of the evaluation steps necessary for the method are carried out by one data processing unit and others are carried out by the other data processing unit. For the sake of simplicity reference is made only to one data processing unit (“the data processing unit”), wherein this expression may disclose each of the aforementioned variants individually and independently.

A comparison may take place in each case between a detected information item (for example detected signal, detected identification feature) and stored information (for example stored signals, stored identification features), such as for the purpose of identification of a stored information item which corresponds to the detected information item.

For the sake of simplicity reference is only made in each case to information (signals, statuses etc.). However, when mention is made thereof, information derived therefrom is also disclosed in each case. For example a detected signal is advantageously evaluated by the evaluating device and/or stored, wherein for this purpose the detected signal can be converted into a form which can be evaluated by the data processing unit and/or a form which can be stored. A conversion from analogue to digital and/or a conversion into a specific file format is for example possible.

The items of information necessary for carrying out the method are correlated with one another for carrying out the method (i.e. for example associated with one another or compared with one another), and are advantageously stored in the form of data. A databank is provided for this purpose. This information may for example include the following: statuses, information relating to statuses, signals, identification features, devices, and/or types of device.

The database and/or the information stored in the database can be located on the portable evaluation device or on a server located remotely therefrom.

All of the information necessary for carrying out the method can be stored in the same database. Alternatively different parts of the information necessary for carrying out the method can be stored in different databases. Different databases can be located on the same device or on different devices (for example the evaluation device or server). Said different devices can be located at the same location or remotely from one another and/or can be in contact with one another via communication links (for example via a local communications network or via the internet). For the sake of simplicity reference is made only to one database (“the database”), wherein this expression may disclose each of the aforementioned variants individually and independently.

The database and/or the information stored in the database (in the form of data) are advantageously stored on one or more data storage media.

In the database a status of the device is associated with the stored signal. Information may be associated with the status. This information is designated as “information about the status” in order to distinguish it from the “information” described above (the “information” can also include the “information about the status”).

Optionally in the database a device or device type can additionally be associated with a stored signal and/or a stored status.

Furthermore it is provided that the information about the status, which is associated with the detected signal in the database, is displayed by means of the display means of the portable evaluation device.

Information about the status can for example include: Identification of the status (for example “malfunction”, “error code”) and/or description of the status (for example “a contact of the relay is broken”) and/or status-related instructions to the user (for example instructions to change the status, for example for error correction, or an instruction to contact a person or company). Such instructions could be provided to the user for example by the execution of a program (for example in the form of a help wizard program) which indicates to the user the next step (or steps) to be carried out in order to change the status (for example in order to remedy a malfunction of the device).

The information about the status can be indicated or displayed in visual form (for example signs or images) and/or acoustic form (for example tone sequence or speech output) by the display means. The information about the status of the display means may be displayed in the form of signs (for example letters or figures) and/or images.

It is advantageous if a plurality of statuses are stored in the database and information (information about the status) is associated in each case with these statuses.

When in this document it is mentioned that an information item has another information item associated with it, the reference to these information items may means in each case the variants of these information items stored in the database.

The detected information (for example detected signal, detected identification feature) can be stored as described above (such as temporarily, for example for the duration of the method step for which it is required) and optionally later (for example after the method has been carried out) can be deleted again. It is nevertheless designated as “detected information” in order to distinguish it from the information of the same type which is stored in the database, that is to say the “stored information” (for example stored signal, stored identification feature).

However, the description of details is made somewhat more difficult by the distinction between “detected information” and “stored information”. Therefore for the sake of simplicity it may be mentioned that a detected information item (for example detected signal, detected identification feature etc.) has another information item (for example status, information about the status, device, device type, etc.) associated with it. Then, however, this means that the stored variants of this information (for example stored signal, stored identification feature, stored status, stored device type, etc.) are associated with one another. Thus in such embodiments (if a comparison takes place between a detected information item and stored information of the same type) in each case it is implicitly disclosed that the detected information is compared with stored information of the same type (for example detected signal compared with stored signals) and the stored information (for example a specific stored signal) corresponding to the detected information (for example detected signal) is the subject of the described association. However, there is also detected information which does not have to be compared with stored information (for example date, clock time, location). If in this connection reference is made to an association, it is implicitly disclosed that such detected information is stored and the resulting stored information is the subject of the described association.

An association in each case may take place or exists between stored information and/or between information of different types.

The detected information can also include one or more of the following: date; clock time; location; sensor information; network information.

Thus in addition to the detected signal the detected information can also include other information (in particular time-dependent information). While the detected signal is detected by the sensor, this other detected information can also be detected by other means, for example by a position determining instrument (for example satellite navigation receiver such as GPS and/or GLONASS receiver) and/or by a time measuring instrument. These means can be part of the evaluation device.

A detected information item can be stored temporarily or without a time limit. If it is stored without a time limit, in corresponding configurations it is implicitly disclosed either that the detected information is stored and so is converted into stored information or that the detected information is compared with stored information of the same type and the stored information corresponding to the detected information is used (if such a comparison is provided, such as for example in the case of signals or identification features). This enables an assignment of the detected information to other information (of a different type), wherein this other information is stored information which itself has optionally been detected beforehand.

It is sensible to link detected information with further information, in particular detected information (i.e. the information items are associated with one another) and to store it in linked form.

It is possible for example to link information, in particular the detected signal, with a date, a clock time, a location and/or a device etc.

As part of the method information can be associated with other information (in particular information of a different type). For example in this way events can be logged, and time information (for example a date and/or a clock time) can be detected, stored and associated with a status. In this way it is possible to establish when a change to the status, for example an error, has occurred.

When the expression “information” is mentioned this may mean information generally, but may mean the types of information referred to in this document. If it is not mentioned that information (for example a detected signal or a detected identification feature) is information stored in the database, the information is disclosed in the described form (for example detected signal or detected identification feature) and alternatively as a variant of this information stored in the database (for example stored signal, stored identification feature). This should result in avoidance of the repeated explanation that an information item is compared with stored information of the same type and then the stored information identified by means of the comparison is used.

The information can for example include one or more of the following: date; clock time; sensor information; network information; name; priorities, etc. Such information can serve for the traceability or reproducibility of the status (for example an erroneous status of the device), or can facilitate the control of and/or change to (in particular repair) the status. However, it may also be useful for limitation of the fault effect, etc.

As described, information items can be associated with one another, wherein they can be associated with one another as part of the method or alternatively they can already be present in the database in assigned form. For example, priorities which are associated with other information (for example statuses) can define the sequence of the evaluation of this information.

It may be provided that one or more of the information items, (in particular the detected signal or information associated therewith such as for example the status of the device) are transmitted from the evaluation device to a server and/or vice versa by means of a communication device of the portable evaluation device. This is particularly advantageous if, as described above, specific information necessary for carrying out the method or individual method steps is not present on the portable evaluation device but on said server and/or if some of the method steps are carried out by the server.

The server can optionally evaluate and/or store the received information. For example, as part of an evaluation a comparison of the received information with and/or an association of the received information with one or more further information items stored on the server can take place. The result of the evaluation can then be transmitted in the form of information from the server to the evaluation device. It would for example be possible for a service company or an instrument manufacturer to operate a server with a database on which the received information is stored and evaluated, and then information (for example instructions to the user) is transmitted to the evaluation device and is displayed there or a service engineer is sent out.

It may be advantageous if the device and/or the status indicator has an identification feature or emits one. The identification feature is designed to identify the device (individually) or the device type. The identification feature may enable one device to be distinguished from another device, wherein the other device may be identical or different with regard to its design.

The identification feature can be emitted in the form of an identification signal for example by the status indicator, such as by means of the same emitters or by means of the same type of emitters which are also used for the emission of the signal. The expression “identification signal” is used at this point for distinguishing from the expression “signal” which is used for display of the device status. However, this is referred to below as an “identification feature”.

It is also possible for the identification feature to be located on or in the device. It can advantageously be applied to the surface of the device, for example on the device housing. The identification feature may be present in the form of a character string (for example including letters and/or numbers) or in the form of a code (for example barcode or data matrix, i.e. “two-dimensional barcode”). The identification feature can optionally be applied to the surface of the device, in particular the device housing (for example as a badge, label, imprint and/or color, including black and white).

A further possibility is that the external shape of the device or the external shape of parts of the device itself constitute the identification feature.

However, the described possibilities can also be combined, i.e. a part of the identification feature may be present in one of the described forms, whereas a further part is present in another of the described forms. The different parts of the identification feature can then for example include different information about the device (for example manufacturer, type, serial number, country etc.).

It is particularly desired if the identification feature can be detected in the same position of the portable evaluation device (position of the evaluation device relative to device and/or relative to the status indicator) as the signal emitted by the status indicator. Alternatively or in addition it is desirable if the signal and the identification feature can be and/or are detected simultaneously by the evaluation device. In this way it is made possible that the two information items are detected, without the evaluation device being moved relative to the device between the detection of the signal and the detection of the identification feature.

When an identification feature is present the method can additionally comprise the following steps:

The identification feature can be detected by means of a sensor of the portable evaluation device, such as by means of the same sensor which is also used for detection of the signal.

The detected identification feature can then be compared with identification features which are stored in the database. By the comparison a stored identification feature is identified which corresponds to the detected identification feature.

A device or a device type is advantageously associated in each case with the stored identification features in the database. In this connection “device” and “device type” are information items relating to the device (for example a serial number, device type designation etc.).

Alternatively or in addition thereto it may also be provided that different devices and/or device types (i.e. information relating thereto) are stored in the database and can be selected manually by the user, for example via a GUI (graphical user interface) which is displayed on the display means. It is desirable if the user itself in this case identifies and then selects the device, for example by visual inspection.

The possibility also exists of combining these variants. For example the identification feature can enable a preselection and the user then selects a device or a device type manually from a reduced number of possibilities.

In each case one or more of the stored signals may be associated with the stored identification feature and/or devices and/or device types. Advantageously a set of different signals is associated with each device type.

On the other hand a stored signal can be associated with one or more of the stored identification features and/or the devices and/or the device types. The same signal can for example be used for different device types.

If a stored signal is associated with a plurality of identification features and/or devices and/or device types, the association of the detected signal with a device or device type and/or the comparison of the detected signal with the stored signals and/or the evaluation the result of this comparison take place as a function of the detected identification feature and/or as a function of the manually selected device or device type.

Moreover the apparatus or apparatus parts (for example portable evaluating device, server, device, status indicator, system for signal evaluation etc.) described in this document are disclosed with one or more of the features described in this document and/or for carrying out the method described in this document. The evaluation device can be a handheld device.

Actions which are disclosed in the form of aptitudes, capabilities, characteristics or functions of the apparatus or apparatus parts described in this document are also disclosed (independently and in any combination) as steps of the method, dependent upon and independently of the corresponding apparatus or the corresponding apparatus part. In this connection information stored in the form of data can also be regarded as apparatus parts. For example the reference to the fact that information can be displayed is also a method step which provides for the display of the information. Moreover the uses of features of the described apparatus or apparatus parts (or the actions made possible by these features) may be disclosed as steps of the method. Conversely the disclosed apparatus or apparatus parts can have means which can carry out one or more of the method steps referred to in connection with the disclosed method and/or are designed therefor. For example the reference to the fact that information is displayed also discloses a means for display of the information.

Expressions used in this document should be understood as they would be understood by a person skilled in the art in this field. If several interpretations are possible in the respective context, any interpretation is disclosed individually. In particular in the event of a lack of clarity, as an alternative or in addition the definitions set out in this document can be used.

In this document, both when the definite article (for example “the”) is used and also when the indefinite article (for example “a”) is used in connection with an object, unless otherwise stated the object should be disclosed without establishing whether this is the same object with the same designation which is mentioned elsewhere. Independently of this it should be disclosed that any mention of an object with the same designation relates to the same object. This applies to all objects mentioned in the singular.

If an object is mentioned in this document, this does not preclude the presence of additional objects of the same type. In other words when an object is mentioned, in each case “at least one” such object and “one or more” such objects are disclosed. One, two, three or more or even all of the additional objects can optionally have the same features as the one object.

Thus the following are disclosed inter alia:

(A) A method for evaluation of signals from a status indicator of a device, wherein the device may be a safety apparatus, comprising the steps
detection of a signal emitted by the status indicator by means of a sensor of a portable evaluation device, wherein the sensor may be an optical sensor and or a camera,
comparison of the detected signal with signals stored in a database, wherein a status is associated in each case with the stored signals in the database, and identification of a stored signal (from the quantity of the aforementioned stored signals) which corresponds to the detected signal, and
display of information about the status which is associated with the identified stored signal by means of a display means of the portable evaluation device. The information about the status may describe the status of the device.

Alternatively or in addition the information about the status includes hints (in particular instructions) for changing the status which may be aimed at the user of the evaluating device and/or of the device.

(B) A method according to point (A), wherein the emitted signal in the form as emitted by the status indicator is not distinguishable or not unambiguously distinguishable by the human eye from other signals which can be emitted by the status indicator and/or is not perceptible. The signals which can be emitted are signals for the emission of which the status indicator is designed and/or programmed.

(C) A method according to one of the points (A) or (B), wherein the detected signal or information derived therefrom (in particular information about the detected signal or information about the status which is associated with the detected signal) is transmitted from the evaluation device to a server. The transmission may take place by means of a communication device of the portable evaluating device. It is desirable if information derived from the aforementioned transmitted signals or information is then transmitted by the server back to the evaluation device.

(D) A method according to one of the points (A) to (C), wherein the device has an identification feature and the method additionally comprises the following steps:
detection of the identification feature, may be by means of the aforementioned sensor of the portable evaluation device,
display of the information about the status as a function of the detected identification feature, wherein the status is the aforementioned status associated with the identified stored signal and the display takes place by means of the display means of the portable evaluating device.

Alternatively a display of the information about the status can also generally take place as a function of the detected signal and as a function of the detected identification feature.

(E) A method according to one of points (A) to (D), wherein the identification feature can be detected and may be detected in the same position of the portable evaluation device relative to the device (by means of the evaluation device) and/or relative to the status indicator), like the signal emitted by the status indicator.

(F) A method according to one of the points (A) to (E), wherein the method additionally comprises the following steps:
comparison of the detected identification feature with identification features stored in the database, wherein a device or a device type is associated in each case with the stored identification features in the database and/or one or more of the signals stored in the database are in each case associated with the stored identification features in the database, and
identification of a stored identification feature (from the quantity of the aforementioned stored identification features) which corresponds to the detected identification feature,
as by comparison of the detected signal with the signals which are stored in the database and are associated with the identified stored identification feature, and identification of a stored signal (from the quantity of the aforementioned stored signals which are associated with the identified stored identification feature), which corresponds to the detected signal, and
display of information about the status which is associated with the aforementioned identified stored signal, by means of the display means of the portable evaluation device.

(G) A method according to one of the points (A) until (F), wherein the status indicator has emitters, wherein the signal and/or the identification feature is characterized by the one or more colors (or more generally: wavelengths) of the emitter and/or by the flashing frequency of the emitters and/or by the flashing sequence of the emitters and/or by the selection of the emitters which are active (i.e. emissive) during a specific time.

(H) A portable and/or hand-held evaluation device for carrying out the method according to one of the points (A) to (G).

A system for carrying out the method according to one of the points (A) to (G), containing a device with a status indicator as well as a portable evaluation device according to one of the points (A) to (E) and optionally a server.

A device with a LED status indicator (for carrying out of the method according to one of the points (A) to (G)), wherein the LED status indicator is designed to emit signals (such as in the form of visible light) which are not distinguishable or not unambiguously distinguishable from one another by the human eye, wherein different signals are determined by different statuses of the device.

Method according to one of the points (A) to (G), wherein in addition to the display of information about the status as a function of the identified stored signal further actions are carried out, wherein:
the detected signal or information derived therefrom is transmitted from the evaluation device to a server and/or
in a network of devices, including the device with the status indicator, which are designed to collaborate, the type of this collaboration is modified and/or
a communication link is established to another person who is located at a different location than the user of the evaluation device.

Generally the configurations of reactions to different statuses are disclosed, in particular as a function of the status which is associated with the identified stored signal. Possible reactions can for example include one or more of the following: dispatch of a message to third parties, alerting specific institutions or persons, display of instructions for further procedure or initiation or determination of measures in a network of devices (for example sensors) which also includes the device with the status indicator. Such measures can for example be advantageous in a network of sensors which for reasons of cost are switched successively, or sensors which must function continuously, or at all events in virtual “sub-systems” which serve for abstraction of the network.

Moreover the following claims are additionally in each case disclosed with a reference back to any of the preceding claims (“according to one of the preceding claims”), even if they are not claimed in this form.

### BRIEF DESCRIPTION OF THE DRAWING

In the schematic drawing which is not true to scale:

FIG. 1 shows a signal evaluation system.

### DETAILED DESCRIPTION OF THE INVENTION

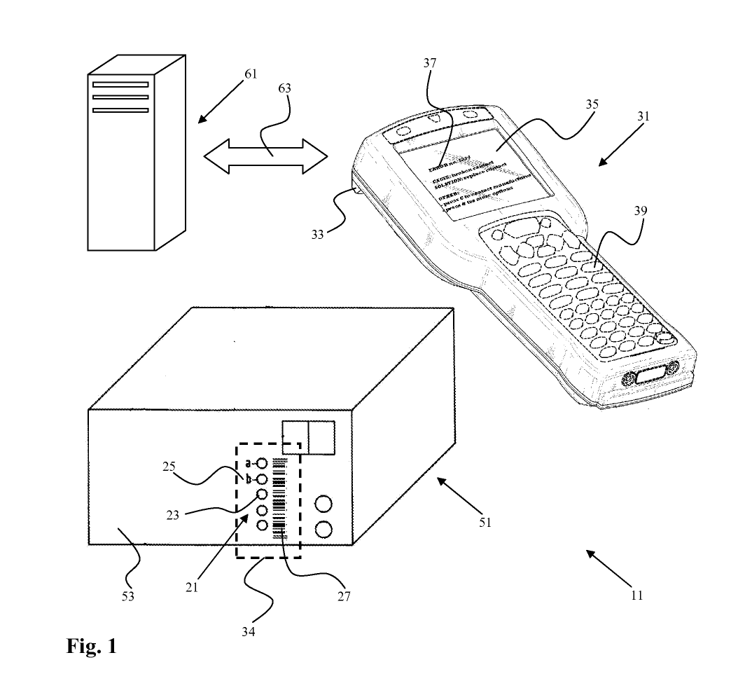

The invention is explained below by way of example with reference to FIG. 1.

This shows a system 11 for evaluation of signals from a LED status indicator 21. The system 11 comprises any device 51 having a LED status indicator 21 as well as an evaluation device 31, which is portable and/or is hand-held during use, as well as optionally a server 61.

The device 51, for example a safety switch, can be in different (operational) states, for example a normal operational state, an inactive state or a disrupted or defective state. The current state or the status of the device 51 is indicated by means of the LED status indicator 21. This has a plurality of LEDs (light-emitting diodes) 23 which can emit electromagnetic radiation of the same or different wavelength. Reference is also made below to a signal, the signal being characterized by the emission of the LEDs.

In the present example the LEDs 23 of the status indicator 21 emit in the wavelength range which is visible to the human eye and (regardless of this fact) these LEDs indicate the status of the device 51 by their color (or general wavelength) and/or their flashing frequency and/or their flashing sequence and/or the selection of the LEDs 23 which are active, i.e. emissive, during a specified time in the status indicator 21. The use of visible light makes it possible for the status to be detected and identified directly by the human eye, as is usual for LED status indicators.

However, the statements in this document including the description of the drawing are also applicable to emitters other than LEDs.

A flashing sequence can for example be characterized by time intervals of different lengths for the emission between consecutive emissions from one or more emitters. Alternatively or in addition a flashing sequence can be characterized by a specific sequence of the emission from different emitters of the status indicator.

In order to simplify the interpretation of the signal and thus the identification of the status of the device 51, the individual LEDs 23 can be provided with an inscription 25.

However it is also possible that the or a signal from the LED status indicator 21 is not perceptible by the human eye in such a way that a status can be associated unambiguously with the or a signal. For example a signal characterized by the flashing frequency and/or flashing sequence of the LEDs 23 can be emitted so quickly that the aforementioned effect occurs. Such signals can be detected and evaluated by the evaluation device 31.

Normally it is advantageous if the status indicator 21 emits the signal in a form (first form) which makes it possible that the status can be detected and identified directly by the human eye (designated above more generally as a “signal which can be detected by a human”). The evaluation device 31 can then simplify the association of the signal with a status.

However it can also be provided that the signal is emitted in a form (second form) which is not perceptible by the human eye in such a way that a status can be associated unambiguously with the signal (designated above more generally as a “signal which cannot be detected by a human”).

For example some of the LEDs 23 emit the status as a signal in the first form and other LEDs emit the status in the second form. However, it is also possible that the LEDs 23 or some of them emit or are designed to emit the status as a signal both in the first form and also in the second form. For example a LED which is perceived by the human eye merely as uniformly lit (for example together with the emission from further LEDs as part of a signal emitted in the first form) may actually be flashing in a fast imperceptible sequence, which can constitute a signal in the second form.

If it is provided that the status indicator 21 emits the signal exclusively in the second form, the number of LEDs can be substantially reduced, in the extreme case to only one LED 23. It is also possible for the time necessary for the detection of the signal to be reduced by the use of an evaluation device 31.

The evaluation device 31 can be designed to detect signals in the first form and/or in the second form. The disclosed ways (cf. above) in which a signal can be emitted (flashing sequence, flashing frequency, time interval of the emission etc.) can apply to signals in the first form and/or signals in the second form. Moreover are they not limited to the emission in the wavelength range which is visible to the human eye (cf. above).

Naturally the signal in the first form must be emitted in the visible wavelength range. The signal in the second form can be emitted in the wavelength range which is visible and/or invisible to the human eye. For example the use of infrared LEDs is conceivable.

When the evaluation device 31 is used, the evaluation of the signal can take place as a function of a marking, in particular an inscription 25, of the LEDs which is detected by the sensor 33. The inscription 25 can optionally also serve to distinguish the LEDs 23 which are provided for the emission of a signal in the first form from those which are provided for the emission of a signal in the second form. Accordingly the evaluation device 31 can be designed to detect the inscription (or more generally a marking) on the device or the status indicator and to perform the detection and/or the evaluation of the signal or the signals as a function of the inscription (or marking).

A special application resides in the fact that the signals emitted by the status indicator 21 are characteristic for the device 51, that is to say they can be associated unambiguously with a device 51 or a device type. However, it may also be provided that the device 51 has an identification feature 27 which contains information about the device and/or device type. The identification feature can be applied for example in the form of a marking which is described above. Advantageously the identification feature 27 is positioned so that it can be detected simultaneously with the status indicator 21 by the sensor 33 of the evaluation device 31. In FIG. 1 this is illustrated by way of example so that the status indicator 21 and the identification feature 27 are disposed within an area 34 which can be detected by the sensor 33. The evaluation of the detected signal by the evaluation device 31 can take place when an identification feature 27 is present as a function of the detected identification feature 27.

A signal evaluation can for example proceed as follows: The status indicator 21 indicates the status of the device 51 by emitting a signal which can be associated with the status by means of one or more emitters, for example LEDs 23. The signal is detected by a sensor 33 of an evaluation device 31, wherein the evaluation device 31 can additionally detect an optional identification feature 27. Then the detected signal is compared with signals stored in a database, wherein the database can be located on the evaluation device 31 or on a server 61. In the latter case the evaluation device 31 can communicate the detected signal or information about it to the server and/or can retrieve data from the database. Accordingly the comparison of the detected signal with signals from the database can be carried out by the server or by the evaluation device 31. The signals in the database are in each case associated with a device status and/or information about a device status. Thus the device status which is associated with the signal corresponding to the detected signal is identified by the comparison. The information about the device status or a part thereof is then displayed by means of a display means 35 of the evaluation device 31. The displayed information can for example include one or more of the following: The designation of the status, a description of the status (for example features of the status, such as causes or possible effects of the status, etc.), instructions for changing the status, contact information of the device manufacturer, etc.

If an identification feature 27 is provided on the device, an identification feature can additionally be associated with the signals which are stored in the database and with which a status is associated in each case in the database. Consequently the comparison of the detected signal with signals stored in the database can take place as a function of the detected identification feature.

The displayed information can be influenced by optional operating elements 39 (or more generally an “input means”); for example parts of the information can be faded out or faded in or a selection can be made between displayed information items (for example different device types). The information can be displayed by the display means 35 by means of a GUI (graphical user interface). Furthermore it may be possible by actuation of the operating elements 39 to make contact with the manufacturer of the device 51 or with a service company.

The evaluation device 31 advantageously has—for example for the aforementioned purpose—communication means for example for transmitting sound and/or images, The optional communication means can facilitate the exchange of information and/or data 63 with the server 61 and/or with remote persons and/or with said manufacturer or service company. The server 61 can for example be operated by the device manufacturer.

1-11. (canceled)

12. A method of evaluating signals from a LED status indicator of a device, comprising:
detecting a signal emitted by a LED status indicator on a device with a camera of a portable evaluation device;
comparing the detected signal detected by the portable evaluation device with signals stored in a database, wherein a status is associated in each case with the stored signals in the database, and identification of a stored signal which corresponds to the detected signal; and
displaying information about the status of the device which is associated with the identified stored signal on a display of the portable evaluation device;
wherein the emitted signal emitted by the LED status indicator is not distinguishable or not unambiguously distinguishable by the human eye from other signals which can be emitted by the LED status indicator.

13. The method of claim 12, wherein the signal emitted from the LED status indicator is emitted completely within less than 3 seconds and wherein a complete emission of the signal lasts longer than 0.01 seconds.

14. The method of claim 12, wherein the emitted signal is not perceptible by the human eye and is emitted in the form of electromagnetic radiation in the invisible wavelength range.

15. The method of claim 12, wherein the detected signal or information derived therefrom is transmitted from the portable evaluation device to a server or a network of devices, including the device with the LED status indicator, which are configured to collaborate.

16. The method of claim 15, further comprising establishing a communication link to another person who is located at a different location than a user of the evaluation device.

17. The method of claim 12, wherein information about the status that is displayed by the display of the portable evaluation device includes instructions as to how the status can be changed.

18. The method of claim 12, wherein the device has an identification feature and further comprising detecting the identification feature and displaying information about the status of the device as a function of the detected identification feature.

19. The method of claim 18, wherein the identification feature can be detected by the portable evaluation device in the same position of the portable evaluation device relative to the device as when detecting the signal emitted by the LED status indicator of the device.

20. The method of claim 18, further comprising:
comparing the detected identification feature with identification features stored in the database and identifying a stored identification feature that corresponds to the detected identification feature of the device or a device type and in each case one or more of the signals stored in the database are associated with the stored identification features in the database;
comparing the detected signal with signals that are stored in the database and are associated with the identified stored identification feature and identifying a stored signal that corresponds to the detected signal and is associated with the identified stored identification feature; and
displaying information on the display of the portable evaluation device about the status that is associated with the identified stored signal.

21. A device, comprising;
a LED status indicator wherein the LED status indicator is designed to emit signals that are not distinguishable or not unambiguously distinguishable from one another by a human eye, wherein different signals are determined by different statuses of a device, and wherein the LED status indicator emits the signals in the form of visible light.

22. The device of claim 21, further comprising a portable evaluation device configured to detect a signal emitted by the LED status indicator, compare the detected signal detected with stored signals indicating a status of the device, and display information about the status of the device that is associated with an identified stored signal on a display of the portable evaluation device, wherein the emitted signal emitted by the LED status indicator is not distinguishable or not unambiguously distinguishable by the human eye from other signals which can be emitted by the LED status indicator.

23. A system, comprising;
a device having a LED usus indicator capable of emitting a signal that is not distinguishable or not unambiguously distinguishable by the human eye from other signals which can be emitted by the LED status indicator;
a portable evaluation device having a camera for detecting a signal emitted by the LED status indicator and configured to compare the signal detected by the portable evaluation device with signals stored in a database, wherein a status of the device is associated in each case with the stored signals in the database, identify a stored signal that corresponds to the detected signal, and display information about the status of the device that is associated with the stored signal on a display of the portable evaluation device.

24. The system of claim 23, wherein the signal emitted from the LED status indicator is emitted completely within less than 3 seconds and wherein a complete emission of the signal lasts longer than 0.01 seconds.

25. The system of claim 23, wherein the signal emitted from the LED status indicator is not perceptible by the human eye and is emitted in the form of electromagnetic radiation in the invisible wavelength range.

26. The system of claim 23, wherein the signal detected by the portable evaluation device or information derived therefrom is transmitted from the portable evaluation device to a server or a network of devices, including the device with the LED status indicator, which are configured to collaborate.

27. The system of claim 26, wherein the portable evaluation device established a communication link to another person who is located at a different location than a user of the portable evaluation device.

28. The system of claim 23, wherein information about the status that is displayed by the display of the portable evaluation device includes instructions as to how the status can be changed.

29. The system of claim 24, wherein the device has an identification feature and wherein the portable evaluation device is configured to detect the identification feature and display information about the status of the device as a function of the detected identification feature.

30. The system of claim 29, wherein the identification feature can be detected by the portable evaluation device in the same position of the portable evaluation device relative to the device as when detecting the signal emitted by the LED status indicator of the device.
